(19) United States
(12) Patent Application Publication
(10) Pub. No.: US 2016/0158931 A1
(43) Pub. Date: Jun. 9, 2016

(54) Hand Tool and Retainer

(71) Applicant: James Edwin Barlow, Kasugai (JP)

(72) Inventor: James Edwin Barlow, Kasugai (JP)

(21) Appl. No.: 14/558,725

(22) Filed: Dec. 3, 2014

(51) Int. Cl. B25H 3/00; B26B 13/00

(52) U.S. Cl. CPC B25H 3/006; B26B 13/00

(57) ABSTRACT

A hand tool and retainer apparatus includes a hand tool and a retainer. The retainer retains the handles in a storage position. The retainer is manually fitted to a proximal end of the hand tool when a user retains the hand tool in a storage position. The retainer limits pivotal movement of the handles. A latch member of the retainer secures the retainer to the hand tool. When the hand tool is retained in the storage position, a button portion of the latch member is located such that manual depression of the button portion allows the retainer to be manually separated from the hand tool from a proximal end of the hand tool. Separation of the retainer from the hand tool allows the handles of the hand tool to pivot away from one another.

### BACKGROUND

The present invention relates to hand tools and in particular, hand tools in which handles are retained in a storage position.

### SUMMARY

Basically, the invention is a hand tool and retainer apparatus. The apparatus includes a hand tool having a pivot joint and a pair of tool components that pivot about a pivot axis of the pivot joint. Each tool component has a distal end and a proximal end, and the pivot joint is located between the proximal end and the distal end of each tool component. Handles are located respectively at the proximal ends of the tool components.

The apparatus includes a spring device connected to the tool components for applying spring forces to the tool components such that the handles are urged in opposite directions, away from one another, about the pivot axis.

The apparatus further includes a retainer that retains the handles in a storage position. The retainer includes retention members, which limit movement of the handles away from one another, and a latch member for securing the retainer to the hand tool. The retainer is manually fitted to the hand tool when a user retains the hand tool in the storage position with the retainer.

The latch member is attached to the retainer by a spring element so that the latch member is movable generally in inward and outward directions with respect to a central axis of the retainer. At least one of the handles includes a socket that receives the latch member when the retainer is fitted to the hand tool. The socket includes an engagement surface, which is formed by a surface of the socket in a location that corresponds to the latch member when the hand tool is retained in the storage position by the retainer. The latch member is biased by the spring element toward the engagement surface to lock the hand tool to the retainer when the hand tool is retained in the storage position by the retainer. The latch member includes a button portion, which is an integral part of the latch member. The button portion is exposed through a button opening in the socket when the hand tool is retained in the storage position by the retainer.

A cam surface is formed by an interior surface of the socket, and the cam surface is positioned to engage the latch member and apply an inwardly directed force to the latch member to deflect the latch member in an inward direction of the retainer when the retainer is being fitted to the hand tool. When the hand tool is retained in the storage position, the button portion is located such that manual depression of the button portion by the user in an inward direction of the retainer causes the latch member to separate from the engagement surface, which allows the retainer to be manually separated from the hand tool from a proximal end of the hand tool. Separation of the retainer from the hand tool allows the handles to pivot away from one another under the spring forces.

In a further example, the retainer is a unitary part of which at least the latch member and the retention members are integral parts.

In a further example, the cam surface is located generally at a proximal end of the socket to engage the button portion and to guide the button portion to the button opening when the retainer is fitted to the hand tool.

In a further example, the socket and the retainer are constructed as separate parts such that upon the separation of the retainer from the hand tool, the hand tool is free from the retainer when the hand tool is performing a tool function.

In a further example, an end opening is formed at the proximal end of the socket, and the end opening is constructed to receive the latch member when the retainer is fitted to the hand tool to retain the hand tool in the storage position.

In a further example, the latch member includes a hooking surface that is adapted to engage the engagement surface when the latch member secures the retainer to the hand tool, and wherein the hooking surface generally faces toward the end opening.

In a further example, the latch member and the spring element form a cantilever beam.

In a further example, the hand tool is a pair of scissors.

In a further example, the engagement surface is located on an edge of the button opening.

In a further example, the latch member is a first latch member of a pair of opposite latch members on the retainer, the engagement surface is a first engagement surface of a pair of opposite engagement surfaces on the hand tool, and the button opening is a first button opening of a pair of opposite button openings in the hand tool.

In a further example, the retention members are located between the latch members on the retainer.

In a further example, a pivotal coupler is formed by the retainer and a second one of the handles, so that the retainer is pivotal with respect to the second one of the handles.

In a further example, the handles have opposed abutment surfaces that limit the movement of the handles toward one another, and the abutment surfaces contact one another when the tool is in retained the storage position.

In a further example, at least sections of the retention members are inclined with respect to a longitudinal axis of the retainer such that a tapered space is defined between the retention members.

In a further example, the socket accommodates one of the retention members when the hand tool is retained in the storage position.

In a further example, the socket houses a distal section of the retainer and exposes a proximal section of the retainer when the hand tool is retained in the storage position.

In a further example, a proximal section of the retainer includes an opening for receiving a support member.

In a further example, the retainer is a unitary plastic part;

In a further example, the invention is a hand tool and retainer apparatus. The apparatus includes a hand tool having a pivot joint and a pair of tool components that pivot about a pivot axis of the pivot joint. Each tool component has a distal end and a proximal end, and the pivot joint is located between the proximal end and the distal end of each tool component. Handles are located respectively at the proximal ends of the tool components.

The apparatus includes a spring device connected to the tool components for applying spring forces to the tool components such that the handles are urged in opposite directions, away from one another, about the pivot axis.

In a further example, the retainer includes means for limiting movement of the handles away from one another.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a front view of a hand tool and retainer apparatus according to a first embodiment;

FIG. 2 is a side view of the apparatus of FIG. 1;

FIG. 3 is a partial cross sectional view with some parts removed taken along plane 3-3 in FIG. 2;

FIG. 4 is a partial cross sectional view of the handles of the apparatus of FIGS. 1-3.

FIG. 5 is a front view of the hand tool of FIGS. 1-4;

FIG. 6 is a front view of the retainer of FIGS. 1-3;

FIG. 7 is a cross sectional view taken along plane 7-7 in FIG. 1;

FIG. 8 is a front view of a hand tool and retainer apparatus according to a second embodiment;

FIG. 9 is a side view of the apparatus of FIG. 8;

FIG. 10 is a partial cross sectional view like FIG. 3 of the apparatus of FIGS. 7 and 8;

FIG. 11 is a partial cross sectional view like FIG. 9 of the apparatus of FIGS. 7-10;

FIG. 12 is a partial cross sectional view like FIG. 3 of a hand tool according to a third embodiment; and

FIG. 13 is a side view of a component of the hand tool of FIG. 12.

### DETAILED DESCRIPTION OF THE PREFERRED EMBODIMENTS

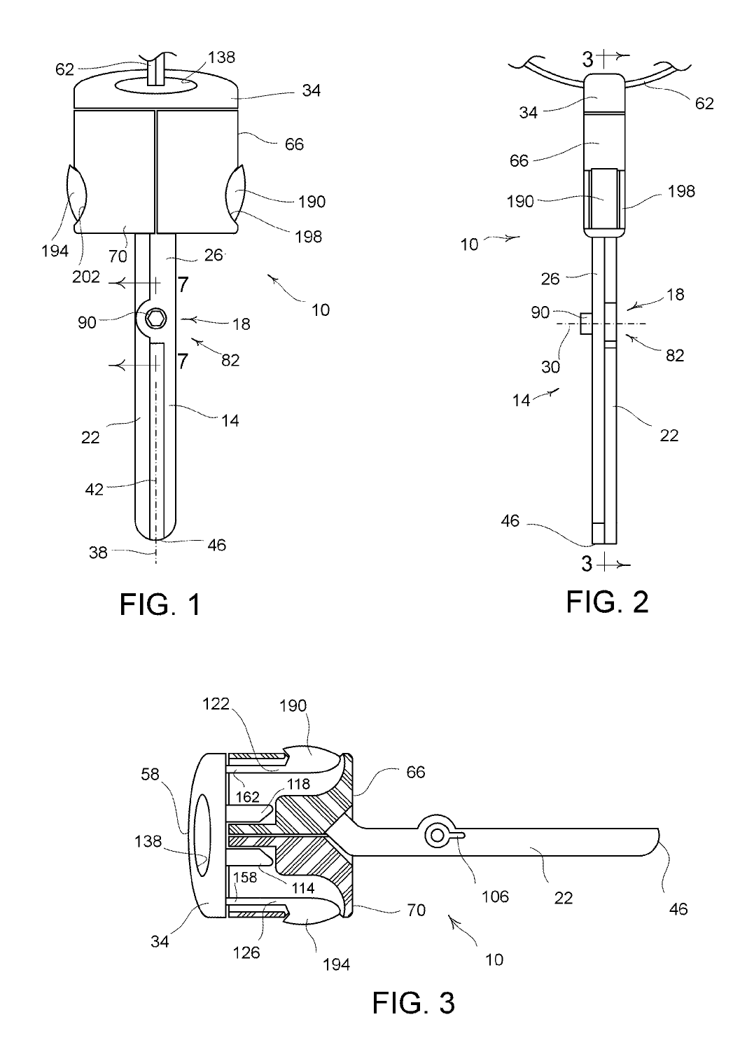

FIG. 1 shows a hand tool and retainer apparatus 10 in a storage position. The apparatus includes a hand tool 14 having a pivot joint 18 and a pair of tool components 22, 26 that pivot about a pivot axis 30 of the pivot joint 18. The apparatus 10 further includes a retainer 34, which is manually fitted to the hand tool 14 when a user retains the hand tool 14 in the storage position.

For reference purposes, the hand tool 14 includes a central longitudinal axis 38, and the retainer 34 includes a central longitudinal axis 42, and the central longitudinal axes 38, 42 are substantially coincident in the storage position of FIG. 1. The hand tool 14 has a distal end 46 and a proximal end 50, and the retainer 58 has a distal end 54 and a proximal end 58. The term “inward” refers to a direction generally toward one of the central longitudinal axes and the term “outward” refers to a direction generally away from one of the central longitudinal axes 38, 42.

The hand tool 14 is preferably a miniature hand tool. The distal end of the hand tool 46 is preferably shaped and sized like the distal part of a conventional automobile key, and the retainer 34 is preferably shaped and sized like a proximal part, or head portion, of a conventional automobile key. The apparatus 10 is adapted to be carried on a key ring 62.

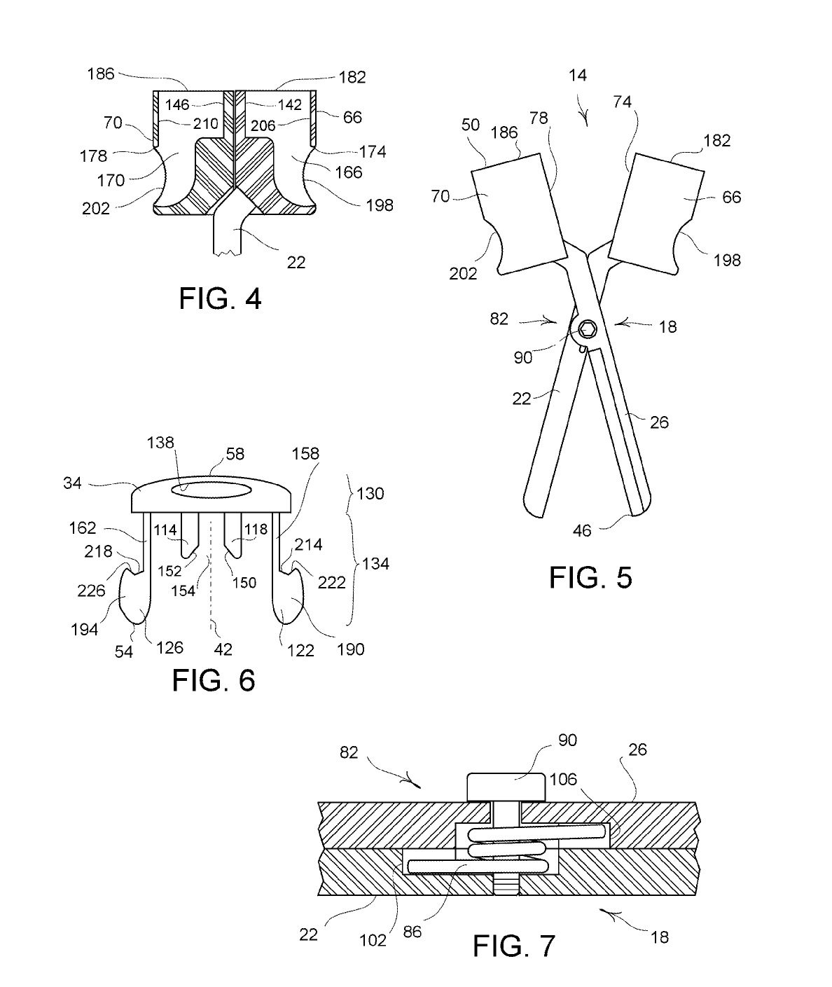

The pivot joint 18 is located between the proximal end 50 and the distal end 54 of each tool component 22, 26. Handles 66, 70 are located respectively at the proximal ends of the tool components 22, 26. In the illustrated embodiments, the hand tool 14 is a pair of scissors. However, the hand tool 14 can be a pair of pliers, wire cutters or the like. The tool components 22, 26 are preferably made of stainless steel. In the embodiments of FIGS. 1-11, proximal ends of the tool components 22, 26 are molded to the handles 66, 70 by, for example, injection molding. The handles 66, 70 are preferably formed by plastic and molded from a strong, resilient, synthetic resin material such as, an aliphatic polyamide, polyoxymethylene, polypropylene, polybutylene terephthalate, or the like.

Opposed surfaces of the handles form abutment surfaces 74, 78 that can contact one another to limit movement of the handles 66, 70 toward one another as shown in FIG. 3. Although FIG. 3 shows a slight gap between the handles 66, 70 when the hand tool 14 is in the storage position, the abutment surfaces 74, 78 can be in contact in the storage position, depending on the manufacturing tolerances of the parts.

Miniature hand tools are typically biased to an open position because the handles are too small to accommodate finger openings that would allow the user to open the tool by finger movement. Since the hand tool 14 is a miniature hand tool, it is preferred that the handles 66, 70 be biased into an open position. Therefore, the apparatus 10 further includes a spring device 82 connected to the tool components 22, 26 for applying spring forces to the tool components 22, 26 such that the handles 66, 70 are urged in opposite directions, away from one another, about the pivot axis 30. For example, FIG. 7 shows a spring device 82 that applies spring forces to the tool components 22, 26.

Referring to FIG. 7, a steel coil spring 86 is placed around a pivot screw 90, which is located on the pivot axis 30 (See FIG. 2). The pivot screw 90, which is preferably made of stainless steel, passes through a hole formed in a second tool component 26. A predetermined clearance is formed between the pivot screw 90 and the second tool component 26 to permit pivotal movement of the second tool component 26 with respect to the pivot screw 90. The distal end of the pivot screw 90 is threaded to a threaded hole formed in a first tool component 22. The pivot screw 90 defines the pivot joint 18 such that the tool components 22, 26 can freely pivot with respect to one another about the pivot axis 30. The coil spring 86 has a first leg 94 and a second leg 98. The first leg 94 is located within a groove 102 formed in the first tool component 22, and the second leg 98 is located within a groove 106 formed in the second tool component 26. The grooves 102, 106 face one another as shown and are substantially hidden when the tool components 22, 26 are assembled. The coil spring 86 is constructed and arranged such that the first leg 94 of the coil spring 86 biases the first tool component 22 in a direction that is opposite to that in which the second leg 98 biases the second tool component 26. Although the coil spring 86 is employed as the spring device in the embodiment of FIGS. 1-7, any of several known spring devices for urging tool handles apart from one another can be employed. For example, a leaf spring that is fixed to one of the tool components 22, 26 such that it engages the other of the tool components 22, 26 can be used instead of the coil spring 86. Also, a coil spring can be employed that is located on the outside of the tool components 22, 26 and is not hidden.

The retainer 34 retains the tool components 22, 26 in a storage position. The retainer 34 includes retention members 114, 118, which limit movement of the handles 66, 70 away from one another, and a latch member 122, 126 for securing the retainer 34 to the hand tool 14. The retainer 34 is preferably a unitary plastic part of which at least the latch member 122, 126 and the retention members 114, 118 are integral parts. The retainer 34 is preferably molded from the same plastic material described above as the preferred material of the handles or similar material.

Referring to FIG. 6, the retainer 34 includes a proximal section 130, which is exposed when the hand tool and retainer apparatus 10 is in the storage position, and a distal section 134, which is housed in the handles 66, 70 when the hand tool and retainer apparatus 10 is in the storage position. The proximal section 130 of the retainer 34 includes an opening 138 for receiving a support member. In the illustrated embodiment of FIGS. 1 and 2, the support member is the key ring 62.

The retention members 114, 118 protrude from the distal end of the proximal section 130 of the retainer 34 and are located between the latch members 122, 126. The retention members 114, 118 extend generally in the direction of the longitudinal axis of the retainer 42. The retention members 114, 118 engage corresponding retention surfaces 142, 146 of the handles 66, 70, such that the retention members 114, 118 limit movement of the handles 66, 70 away from one another when the retention members 114, 118 are engaged with the retention surfaces 142, 146 and the apparatus 10 is in the storage position. As shown in FIGS. 3 and 6, at least sections 150, 152 of the retention members 114, 118 are inclined with respect to the longitudinal axis of the retainer 42 such that a tapered space 154 is defined between the retention members 114, 118. The inclined sections 150, 152 of the retention members 114, 118 engage the retention surfaces 142, 146 and cause the handles 66, 70 to move toward one another as the retainer 34 moves toward the hand tool 14 when the retainer 34 is being fitted to the hand tool 14. Although FIG. 3 shows slight gaps between retention surfaces 142, 146 of the handles and the corresponding retention members 114, 118, the retention members 114, 118 are normally in contact with the retention surfaces 142, 146 when the apparatus 10 is in the storage position of FIG. 3 due to the spring forces. In the embodiment of FIGS. 1-7, each of the retention members 114, 118 is a mirror image of the other, and the retention members 114, 118 are symmetrically located about a central plane of the retainer 34.

The size and shape of the retention members 114, 118 can vary as long as they operate to retain the handles 66, 70 in abutment or in close proximity to one another when the latch members 122, 126 lock the retainer 34 to the hand tool 14. For the latch members 122, 126 to operate properly and for the apparatus 10 to maintain the storage position, separation of the two handles 66, 70 is limited by the retention members 114, 118. When the retainer 34 is manually fitted to the handles 66, 70, the user will normally squeeze the handles 66, 70 together into abutment, which places the retention surfaces 142, 146 near the longitudinal axis 38 of the hand tool 14, which will substantially align the retention surfaces 142, 146 with the tapered space 154 when the retainer 34 is fitted to the handles 66, 70. Although FIG. 6 shows a relatively large gap between each of the latch members 122, 126 and the corresponding retention member 114, 118, the retention members 114, 118 can be in close proximity to the latch members 122, 126 or integrated with the latch members 122, 126 as long as the retention members 114, 118 do not interfere with the function of the latch members 122, 126. In addition, although the retention members 114, 118 in FIGS. 3 and 6 include the inclined sections 150, 152, the inclined sections 150, 152 are preferred but not required. That is, the space between the 114, 118 need not be inclined. Further, the retention surfaces 142, 146 can be inclined to gradually decrease a clearance between the 114, 118 and the retention surfaces 142, 146 as the retainer 34 is inserted further into the handles 66, 70.

The latch member 122, 126 is attached to the retainer 34 by a spring element 158, 162 so that the latch member 122, 126 is movable generally in inward and outward directions with respect to the longitudinal axis 42 of the retainer 34. In other words, at least the spring element 158, 162 is flexible to form a leaf spring. As shown, the latch member 122, 126 and the spring element 158, 162 form a cantilever beam. In the first embodiment of FIGS. 1-7, first and second latch members 122, 126, which are each a mirror image of the other, are provided symmetrically on the retainer 34. In the first embodiment of FIGS. 1-7, the retainer 34 is symmetrical about a central longitudinal plane. Thus, the retainer 34 is reversible and can be fitted to the handles 66, 70 in either of two orientations. This makes it relatively easy for a user to lock the retainer 34 to the handles 66, 70, since the user can use either of two opposite orientations of the retainer 34 when fitting the retainer 34 to the handles 66, 70.

In the first embodiment of FIGS. 1-7, the retention members 118, 122 are separate from the latch members 122, 126, and the retention members 118, 122 are located between the latch members 122, 126 on the retainer 34. However, each of the retention members 118, 122 and the corresponding one of the latch members 122, 126 can be integrated into a single member such that proximal sections of the latch members 122, 126 serve as the retention members 118, 122.

At least one of the handles 66, 70 includes a socket 166, 170 that receives the latch member 122 when the retainer 34 is fitted to the hand tool 14. The socket 166, 170 includes an engagement surface 174, 178, which is formed by a surface of the socket 166, 170 in a location that corresponds to the latch member 122, 126 when the hand tool 14 is retained in the storage position by the retainer 34. In the embodiment of FIGS. 1-7, one socket 166, 170 is formed in each of the handles 66, 70, and one socket 166, 170 corresponds to each of the latch members 122, 126, respectively. In the embodiment of FIGS. 1-7, each of the sockets 166, 170 is a mirror image of the other.

An end opening 182, 186 is formed at the proximal end of the socket 166, 170, and the end opening 182, 186 is constructed to receive the latch member 122, 126 when the retainer 34 is fitted to the hand tool 14 to retain the hand tool 14 in the storage position. In the embodiment of FIGS. 1-7, a pair of end openings 182, 186 is formed at the proximal ends of the sockets 166, 170 for receiving the latch members 122, 126, respectively.

The socket 166, 170 accommodates one of the retention members 114, 118 when the hand tool 14 is retained in the storage position. In the embodiment of FIGS. 1-7, each socket 166, 170 accommodates one of the retention members 114, 118, respectively, when the hand tool 14 is retained in the storage position.

The latch member 122, 126 is biased by the spring element 158, 162 toward the engagement surface 174, 178 to lock the hand tool 14 to the retainer 34 when the hand tool 14 is retained in the storage position by the retainer 34. In the embodiment of FIGS. 1-7, the a pair of engagement surfaces 174, 178, which are mirror images of one another, are provided on the sockets 166, 170, respectively, and each of the latch members 122, 126 is biased by the corresponding spring element 158, 162 toward the corresponding one of the engagement surfaces 174, 178 to lock the hand tool 14 to the retainer 34 when the hand tool 14 is retained in the storage position by the retainer 34.

The latch member 122, 126 includes a button portion 190, 194, which is an integral part of the latch member 122, 126 and is exposed through a button opening 198, 202 in the socket 166, 170 when the hand tool 14 is retained in the storage position by the retainer 34. In the embodiment of FIGS. 1-7, each latch member 122, 126 includes a corresponding button portion 190, 194, which is exposed through a corresponding button opening 198, 202 in the corresponding socket 166, 170 when the hand tool 14 is retained in the storage position by the retainer 34. Each of the button portions 190, 194 is exposed such that fingers can easily depress the button portions 190, 194. The button openings 198, 202 are provided symmetrically on opposite sides of the hand tool 14 in the embodiment of FIGS. 1-7. The button openings 198, 202 are preferably concave as seen in the front view of FIG. 1, which allows greater travel of the button portions 190, 194 when depressed.

The engagement surface 174, 178 is located on an edge of the button opening 198, 202. In the embodiment of FIGS. 1-7, each engagement surface 174, 178 is located on the edge of a corresponding one of the button openings 198, 202. In particular, the engagement surfaces 174, 178 are located respectively at the proximal ends of the button openings 198, 202.

A cam surface 206, 210 is formed by an interior surface of the socket 166, 170. The cam surface 206, 210 is positioned to engage the latch member 122, 126 and apply an inwardly directed force to the latch member 122, 126 to deflect the latch member 122, 126 in an inward direction of the retainer 34 when the retainer 34 is being fitted to the hand tool 14. That is, if the handles 66, 70 are being held in abutment or in close proximity to one another, the cam surface 206, 210 is positioned to engage an outer, or lateral, surface of the latch member 122, 126 when the retainer 34 is being fitted to the hand tool 14. The cam surface 206, 210 is located generally at a proximal end of the socket 166, 170 to engage the button portion 190, 194 and to guide the button portion 190, 194 to the button opening 198, 202 when the retainer 34 is fitted to the hand tool 14. The cam surface 206, 210 extends between the button opening 198, 202 and the end opening 182, 186 of the socket 166, 170. In the embodiment of FIGS. 1-7, the cam surface 206, 210 is a first cam surface of a pair of cam surfaces 206, 210 located at proximal ends of the sockets 166, 170, respectively, in a symmetrical fashion. Each cam surface 206, 210 extends between the end opening 182, 186 and the button opening 198, 202 of the associated socket 166, 170.

In the embodiment of FIGS. 1-7, when the handles are in abutment, the cam surfaces 206, 210 are spaced apart by a predetermined distance such that outer, or lateral, surfaces of the latch members 122, 126 engage the corresponding cam surfaces 206, 210 when the retainer 34 is fitted to the handles 66, 70. Consequently, engagement between the cam surfaces 206, 210 and the corresponding latch members 122, 126 will cause inward flexing of the latch members 122, 126 as the retainer 34 is fitted to the hand tool 14 and moved toward the locked position. In other words, the distance between the cam surfaces 206, 210 is greater than the distance between the distal ends of the latch members 122, 126 when the handles are in abutment 66, 70.

The latch member 122, 126 includes a hooking surface 214, 218 that is adapted to engage the engagement surface 174, 178 when the latch member 122, 126 secures the retainer 34 to the hand tool 14, and the hooking surface 214, 218 generally faces toward the end opening 182, 186 of the socket 166, 170. In the embodiment of FIGS. 1-7, hooking surfaces are provided on the latch members, respectively, and the hooking surfaces 214, 218 generally face corresponding ones of the end openings 182, 186. When the retainer 34 is fully seated in the handles 66, 70, the button portions 190, 194 enter the corresponding button openings 198, 202 under the force of the spring elements 158, 162 and the hooking surfaces 214, 218 engage with the corresponding engagement surfaces 174, 178 to lock the retainer 34 to the handles 66, 70.

As shown in FIG. 3, the hooking surface 214, 218 preferably includes an inclined part 222, 226 such that the inclined part 222, 226 of the hooking surface 214, 218 is located to face an outer part, or lateral part, of the engagement surface when the latch member 122, 126 locks the retainer 34 to the hand tool 14. With this arrangement, incidental contact with the button portion 190. 194 will not release the retainer 34. Sliding engagement between the inclined part 222, 226 of the hooking surface 214, 218 and the engagement surface 174, 178 will force the retainer 34 to move slightly in the distal direction of the hand tool 10 when the button portion 190, 194 is depressed. This makes the retainer 34 more secure by creating slight resistance when the button portion 190, 194 is depressed.

When the hand tool 14 is retained in the storage position, the button portion 190, 194 is located such that manual depression of the button portion 190, 194 by the user in an inward direction of the retainer 34 causes the latch member 122, 126 to separate from the engagement surface 174, 178, which allows the retainer 34 to be manually separated from the hand tool 14 from a proximal end of the hand tool 14. In the embodiment of FIGS. 1-7, manual depression of each of the button portions 190, 194 in opposite directions causes the latch members 122, 126 to separate from the engagement surfaces 174, 178 simultaneously. Separation of the retainer 34 from the hand tool 14 allows the handles 66, 70 to pivot away from one another under the spring forces. When the retainer 34 is fully separated from the hand tool 14, as shown in FIG. 5, the hand tool 14 can perform a tool function without interference by the retainer 34.

Particularly with miniature hand tools such as miniature scissors, maintaining a connection between the retainer 34 and the handles 66, 70 when the retainer 34 unlocks the hand tool 14 may limit the area available for the user's fingers to contact when using the hand tool 14 or may cause interference with the operation of the hand tool 14. Thus, it is preferred that the retainer 34 readily and completely separates from the hand tool 14 when the hand tool 14 is released from the retainer 34. Therefore, the handles 66, 70 and the retainer 34 are constructed as separate parts such that upon the separation of the retainer 34 from the hand tool 14, the hand tool 14 is free from the retainer 34 when the hand tool 14 is performing a tool function. In the embodiment of FIGS. 1-7, both of the sockets 166, 170 are separate and independent from the retainer 34 such that upon the separation of the retainer 34 from the hand tool 14, the hand tool 14 is free from the retainer 34 when the hand tool 14 is performing a tool function.

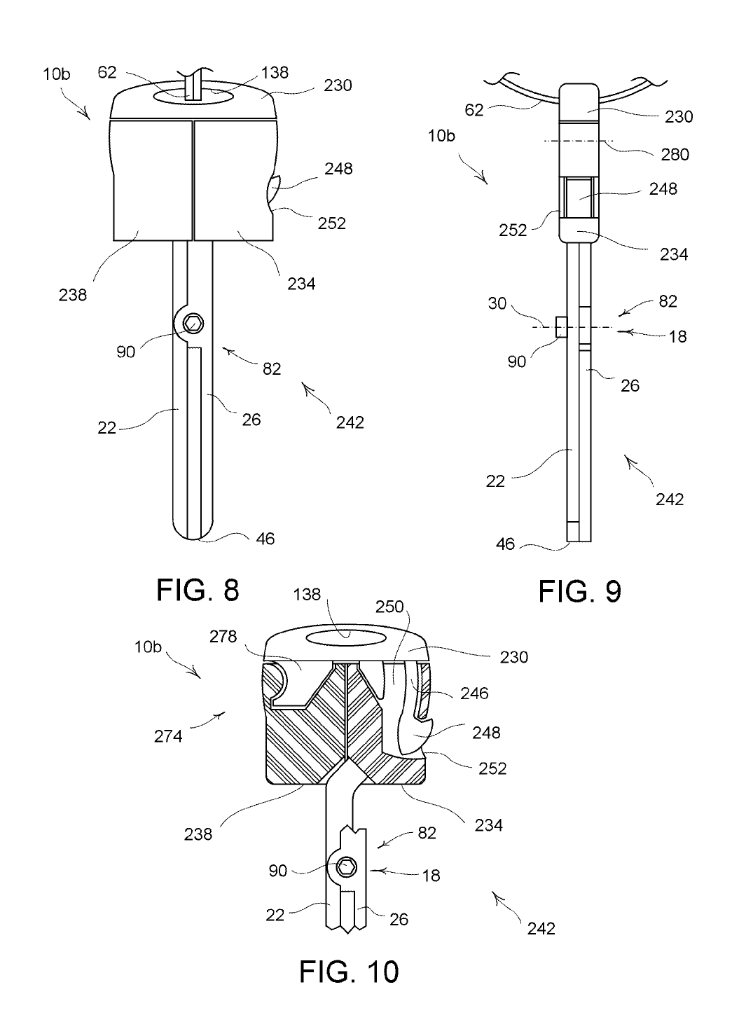

FIGS. 8-11 show a second embodiment of the hand tool and retainer apparatus 10b. The apparatus 10b of the second embodiment is substantially the same as that of the first embodiment except as described below. In the description of the second and subsequent embodiments, reference numbers that are the same or similar to the reference numbers used in the description of the first embodiment may be used to designate parts that are the same as or similar to corresponding parts of the first embodiment.

In the second embodiment of FIGS. 8-11, a retainer 230 retains the handles 234, 238 of a hand tool 242. In this embodiment, the retainer 230 has only one latch member 246, which is accommodated in a socket 250 formed by the first one of the handles 234. A first retention member 254 extends from the retainer 230 and is accommodated in a socket 250. Like the apparatus 10 of the first embodiment, the first retention member 254 contacts a first retention surface 262 on the first handle 234 to limit movement of the first handle 234 when the apparatus 10b is in the storage position. Also, like the apparatus 10 of the first embodiment, when the handles 234, 238 are being held in abutment, the latch member 246 engages a cam surface 270, which is provided on the first handle 234, when the latch member 246 is inserted into the socket 250. A button portion 248 of the latch member 246 enters an opening 252 to lock the retainer 230 to the hand tool 242.

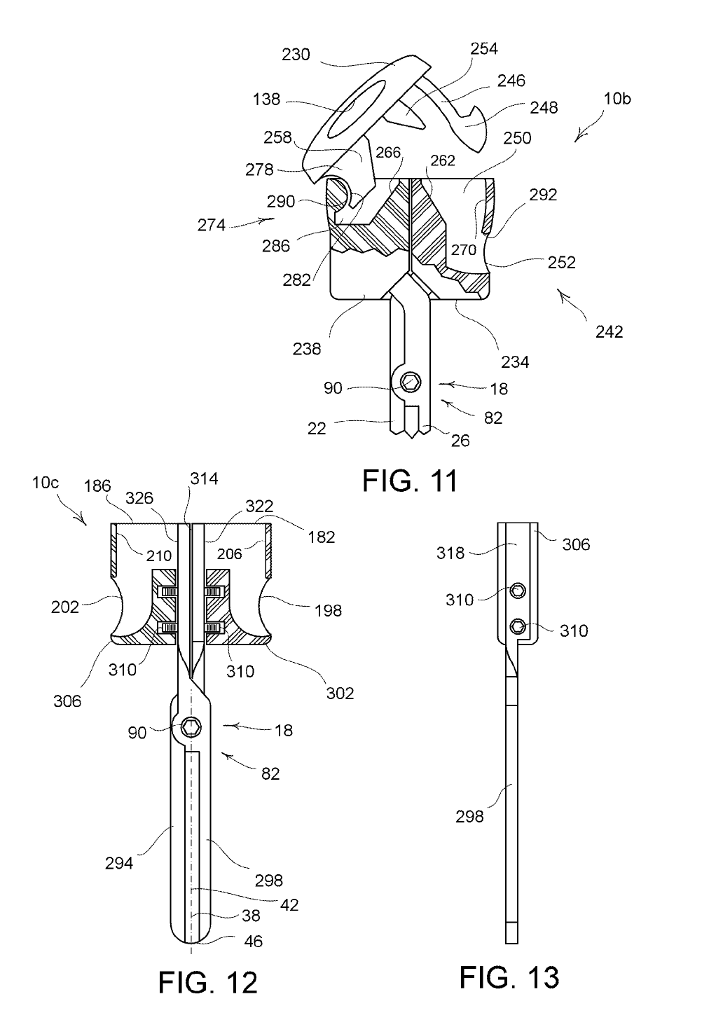

Unlike the apparatus of the first embodiment, as shown in FIGS. 10 and 11, a pivotal coupler 274 is formed by the retainer 230 and a second one of the handles 238, so that the retainer 230 is pivotal with respect to the second handle 238 about a pivot axis 280. The retainer 230 of the second embodiment includes a coupler arm 278. The coupler arm 278 includes a concave surface 282, which forms part of the pivotal coupler 274. In the second handle 238, a receptacle 286 is formed for receiving the coupler arm 278. A convex surface 290 is formed inside the receptacle 286 for engaging the concave surface 282 of the coupler arm 278, which permits the retainer 230 to pivot with respect to the second handle 238.

The coupler arm 278 also provides as a second retention member 258 for limiting movement of the handles 234, 238 away from one another. That is, an inner surface of the coupler arm 278 forms the second retention member 258. The second retention member 258 engages a corresponding second retention surface 266 when the hand tool 242 is retained by the retainer 230.

As shown in FIGS. 10 and 11, the concave surface 282 is engaged with the convex surface 290 to form the pivotal coupler 274 when the retainer 230 is fitted to the hand tool 242. The retainer 230 is then pivoted with respect to the hand tool 242 about a pivot axis 280 of the pivotal coupler 274 to cause the latch member 246 to enter the socket 250 from the proximal end of the hand tool 242. The latch member 246 functions like each of the latch members 122, 126 of the first embodiment and locks the retainer 230 to the hand tool 242. That is, when the handles 234, 238 are held in abutment, the cam surface 270 is located a predetermined distance from the pivotal coupler 274 such that the outer surface of the latch member 246 will engage the cam surface 270 when the retainer 230 is fitted to the handles 234, 238. Consequently, engagement between the cam surface 270 and the latch member 246 will cause inward movement of the latch member 246 as the retainer 230 is manually fitted to the handles 234, 238 and moved toward the locked position.

The pivotal coupler 274 prevents the coupler arm 278 from separating from the second handle 238 when the latch member 246 is locked to an engagement surface 292. To release the retainer 230 from the hand tool, the button is depressed, which disengages the latch member 246 from the engagement surface 292 and allows pivotal movement and separation of the retainer 230 from the hand tool 242 as illustrated in FIG. 10. Since the concave surface 282 of the coupler arm 278 forms only a partial hinge, the coupler arm 278 is readily separable from the second handle 238 when the retainer 230 pivots to a position shown in FIG. 10 when the retainer 230 is released from the handles 234, 238.

FIGS. 12 and 13 show a hand tool and retainer apparatus 10c of a third embodiment. The third embodiment is essentially the same as the first embodiment except that the proximal ends of tool components 294, 298 are fastened to the handles 302, 306 by screws 310 instead of being molded to the handles 302, 306. The heads of the screws 310 are preferably countersunk in the tool components 294, 298 so that the screw heads are flush with the inner surfaces of the tool components 294, 298 as shown in FIG. 12. In this embodiment, the proximal ends of the tool components 294, 298 form opposed abutment surfaces 314, 318 and limit movement of the handles 302, 306 toward one another. In the third embodiment, the retention surfaces 322, 326, which are located to contact the retention members 330, 334, are formed by outer surfaces of the proximal ends of the tool components 294, 298. Alternatively, if the heads of the screws 310 are not countersunk and project from the inner surfaces of the tool components 294, 298, the heads of the screws 310 can form the abutment surfaces 314, 318. Although not illustrated, the apparatus 10c of the third embodiment of FIGS. 12 and 14 includes a retainer 34 that is substantially the same as that illustrated in FIG. 6.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A hand tool and retainer apparatus comprising:
a hand tool having a pivot joint and a pair of tool components that pivot about a pivot axis of the pivot joint, wherein each tool component has a distal end and a proximal end, the pivot joint is located between the proximal end and the distal end of each tool component, and handles are located respectively at the proximal ends of the tool components;
a spring device connected to the tool components for applying spring forces to the tool components such that the handles are urged in opposite directions, away from one another, about the pivot axis;
a retainer that retains the handles in a storage position, wherein the retainer includes retention members, which limit movement of the handles away from one another, and a latch member for securing the retainer to the hand tool, wherein
the retainer is manually fitted to the hand tool when a user retains the hand tool in the storage position with the retainer,
the latch member is attached to the retainer by a spring element so that the latch member is movable generally in inward and outward directions with respect to a central axis of the retainer,
at least one of the handles includes a socket that receives the latch member when the retainer is fitted to the hand tool,
the socket includes an engagement surface, which is formed by a surface of the socket in a location that corresponds to the latch member when the hand tool is retained in the storage position by the retainer,
the latch member is biased by the spring element toward the engagement surface to lock the hand tool to the retainer when the hand tool is retained in the storage position by the retainer,
the latch member includes a button portion, which is an integral part of the latch member and is exposed through a button opening in the socket when the hand tool is retained in the storage position by the retainer,
a cam surface is formed by an interior surface of the socket, and the cam surface is positioned to engage the latch member and apply an inwardly directed force to the latch member to deflect the latch member in an inward direction of the retainer when the retainer is being fitted to the hand tool,
when the hand tool is retained in the storage position, the button portion is located such that manual depression of the button portion by the user in an inward direction of the retainer causes the latch member to separate from the engagement surface, which allows the retainer to be manually separated from the hand tool from a proximal end of the hand tool, and wherein separation of the retainer from the hand tool allows the handles to pivot away from one another under the spring forces.

2. The apparatus of claim 1, wherein the retainer is a unitary part of which at least the latch member and the retention members are integral parts.

3. The apparatus of claim 1, wherein the cam surface is located generally at a proximal end of the socket to engage the button portion and to guide the button portion to the button opening when the retainer is fitted to the hand tool.

4. The apparatus of claim 1, wherein the socket and the retainer are constructed as separate parts such that upon the separation of the retainer from the hand tool, the hand tool is free from the retainer when the hand tool is performing a tool function.

5. The apparatus of claim 1, wherein an end opening is formed at the proximal end of the socket, and the end opening is constructed to receive the latch member when the retainer is fitted to the hand tool to retain the hand tool in the storage position.

6. The apparatus of claim 5, wherein the latch member includes a hooking surface that is adapted to engage the engagement surface when the latch member secures the retainer to the hand tool, and wherein the hooking surface generally faces toward the end opening.

7. The apparatus of claim 1, wherein the latch member and the spring element form a cantilever beam.

8. The apparatus of claim 1, wherein the hand tool is a pair of scissors.

9. The apparatus of claim 1, wherein the engagement surface is located on an edge of the button opening.

10. The apparatus of claim 1, wherein the latch member is a first latch member of a pair of opposite latch members on the retainer, the engagement surface is a first engagement surface of a pair of opposite engagement surfaces on the hand tool, and the button opening is a first button opening of a pair of opposite button openings in the hand tool.

11. The apparatus of claim 10, wherein the retention members are located between the latch members on the retainer.

12. The apparatus of claim 1, wherein a pivotal coupler is formed by the retainer and a second one of the handles, so that the retainer is pivotal with respect to the second one of the handles.

13. The apparatus of claim 1, wherein the handles have opposed abutment surfaces that limit the movement of the handles toward one another, and the abutment surfaces contact one another when the tool is in retained the storage position.

14. The apparatus of claim 1, wherein at least sections of the retention members are inclined with respect to a longitudinal axis of the retainer such that a tapered space is defined between the retention members.

15. The apparatus of claim 1, wherein the socket accommodates one of the retention members when the hand tool is retained in the storage position.

16. The apparatus of claim 1, wherein the socket houses a distal section of the retainer and exposes a proximal section of the retainer when the hand tool is retained in the storage position.

17. The apparatus of claim 1, wherein a proximal section of the retainer includes an opening for receiving a support member.

18. The apparatus of claim 1, wherein the retainer is a unitary plastic part.

19. A hand tool and retainer apparatus comprising:
a hand tool having a pivot joint and a pair of tool components that pivot about a pivot axis of the pivot joint, wherein each tool component has a distal end and a proximal end, the pivot joint is located between the proximal end and the distal end of each tool component, and handles are located respectively at the proximal ends of the tool components;
a spring device connected to the tool components for applying spring forces to the tool components such that the handles are urged in opposite directions, away from one another, about the pivot axis;
a retainer that retains the handles in a storage position, wherein the retainer includes means for limiting movement of the handles away from one another, and a latch member for securing the retainer to the hand tool, wherein
the retainer is manually fitted to the hand tool when a user retains the hand tool in the storage position with the retainer,
the latch member is attached to the retainer by a spring element so that the latch member is movable generally in inward and outward directions with respect to a central axis of the retainer,
at least one of the handles includes a socket that receives the latch member when the retainer is fitted to the hand tool,
the socket includes an engagement surface, which is formed by a surface of the socket in a location that corresponds to the latch member when the hand tool is retained in the storage position by the retainer,
the latch member is biased by the spring element toward the engagement surface to lock the hand tool to the retainer when the hand tool is retained in the storage position by the retainer,
the latch member includes a button portion, which is an integral part of the latch member and is exposed through a button opening in the socket when the hand tool is retained in the storage position by the retainer,
a cam surface is formed by an interior surface of the socket, and the cam surface is positioned to engage the latch member and apply an inwardly directed force to the latch member to deflect the latch member in an inward direction of the retainer when the retainer is being fitted to the hand tool,
when the hand tool is retained in the storage position, the button portion is located such that manual depression of the button portion by the user in an inward direction of the retainer causes the latch member to separate from the engagement surface, which allows the retainer to be manually separated from the hand tool from a proximal end of the hand tool, and wherein separation of the retainer from the hand tool allows the handles to pivot away from one another under the spring forces.
